(19) United States
(12) Patent Application Publication
(10) Pub. No.: US 2011/0047944 A1
(43) Pub. Date: Mar. 3, 2011

(54) HORSEBACK RIDING ASSEMBLY

(76) Inventors: Mary Lorna Longden, Bunyip (AU); Michael William Ipkendanz, Helena Valley (AU)

(21) Appl. No.: 12/547,847

(22) Filed: Aug. 26, 2009

(51) Int. Cl. B68C 1/02

(52) U.S. Cl. 54/44.5; 54/44.1

(57) ABSTRACT

A horseback riding assembly comprises a saddle, the saddle including a body arranged about a central axis. The body has a proximal region to be adjacent a neck region of a horse. The body includes a pair of lateral portions extending outwardly from the central axis, each of the lateral portions having an inner panel portion providing an inner surface region for engaging a corresponding back region of the horse. An outer panel portion provides an outer surface for receiving a corresponding thigh region of a horseback rider. The body includes an access path between the inner panel portion and the outer panel portion. An assistance bar unit includes a gripping bar portion arranged to be oriented transverse to the central axis and adjacent the proximal region. The gripping bar portion has a pair of opposed end regions and a pair of support portions, each extending from a corresponding end region. The support portions are arranged to be located on opposite sides of the central axis and being formed to be insertable along the access path and between the inner panel portion and the outer panel portion and to complementary therewith.

### FIELD OF THE DISCLOSURE

The present invention relates to riding assistance devices for saddle assemblies to be used for horseback riding and the like.

### DESCRIPTION OF THE RELATED ART

Equestrian sports continue to be popular among a growing number of people including young children, including those with physical and/or mental challenges. Even among able bodied and minded riders, there is awareness that horses can be, at times, unpredictable. Thus, horseback riders can sometimes have a fear of climbing into a saddle with relatively little to reach for in the event of wanting greater security in maintaining balance in the saddle. When a rider feels unbalanced or insecure in the saddle, a rider has had to resort to grabbing hold of the mane, a neck strap or the reins or a part of the saddle none of which provide any great degree of stability. The use of any of these options can also lead to the horse reacting to a perceived signal from the rider which causes the rider to further lose control of their mount.

It would be desirable to provide a novel approach to address this issue.

### SUMMARY OF THE DISCLOSURE

In one of its embodiments, the present invention provides a horseback riding assembly comprising a saddle, the saddle including a body arranged about a central axis. The body has a proximal region to be adjacent a neck region of a horse. The body includes a pair of lateral portions extending outwardly from the central axis, each of the lateral portions having an inner panel portion providing an inner surface region for engaging a corresponding back region of the horse. An outer panel portion provides an outer surface for receiving a corresponding thigh region of a horseback rider. The body includes an access path between the inner panel portion and the outer panel portion. An assistance bar unit includes a gripping bar portion arranged to be oriented transverse to the central axis and adjacent the proximal region. The gripping bar portion has a pair of opposed end regions and a pair of support portions, each extending from a corresponding end region. The support portions are arranged to be located on opposite sides of the central axis and being formed to be insertable along the access path and between the inner panel portion and the outer panel portion and to complementary therewith.

In some embodiments, the inner panel portion includes a saddle pad member and the outer panel portion includes an outer saddle flap.

In some embodiments, each support portion including a longitudinal brace portion, each longitudinal brace portion having a flattened profile with a pair of opposed surfaces which are generally symmetrically aligned with a longitudinal brace axis.

In some embodiments, each support portion includes a longitudinal brace portion, with a flattened profile and a pair of substantially planar opposed surfaces which are generally symmetrically aligned with a longitudinal brace axis.

In some embodiments, the longitudinal brace portion has a flattened profile with a pair of substantially planar opposed surfaces. The opposed surfaces may be arranged to be inclined toward the central axis.

Some embodiments further comprise a pair of strut portions, each being inclined between and joining the gripping bar portion with the corresponding support portion.

In some embodiments, the gripping bar portion, the support portion and the strut portions are integrally formed of a single tubular blank, though other configurations may also be utilized.

Some embodiments, further comprise a cover layer extending along the gripping bar portion and at least part of each strut portion and/or the support portion. The cover layer may be provided, for example, as a resilient material, such as a polymer and/or rubber material.

Some embodiments further comprise at least one fastener for removably securing each support portion with the inner panel portion and/or the outer panel portion.

In an alternative embodiment, there is provided a horseback riding assembly comprising a horse having a neck region and a back region having a left hand side and a right hand side. A saddle is positioned on the horse. The saddle includes a body symmetrically arranged about a central axis. The body has a proximal region to be adjacent the neck region. The body includes a left hand lateral portion and a right hand lateral portion extending outwardly from the central axis. Each of the lateral portions has an inner panel portion providing an inner surface region engaging the corresponding back region, and an outer panel portion providing an outer surface for receiving a corresponding thigh region of a horseback rider. The body includes an access path between the inner panel portion and the outer panel portion. An assistance unit includes a gripping bar portion oriented transverse to the central axis and adjacent the proximal region. The gripping portion has a pair of opposed end region. The assistance bar unit further includes a pair of support portions, each extending from a corresponding end region. The support portions are located on opposite sides of the central axis and located within the access path in an operative orientation complementary with the inner panel portion and the outer panel portion.

In another alternative embodiment, there is provided a method of horseback riding, comprising:
providing a horse with a neck region and a back region having a left hand side and a right hand side,

providing a saddle with a body arranged about a central axis, a proximal region to be adjacent the neck region, the body including a left hand lateral portion and a right hand lateral portion extending outwardly from the central axis, each of the lateral portions having an inner panel portion providing an inner surface region engaging the corresponding back region, and an outer panel portion providing an outer surface for receiving a corresponding thigh region of a horseback rider, the body including an access path between the inner panel portion and the outer panel portion,
providing an assistance bar unit with a gripping bar portion having a pair of opposed end regions and a pair of anchor portions, each extending from a corresponding end region,
installing the saddle on the horse;
locating the support portions on opposite sides of the central axis and within the access path in an operative orientation complementary with the inner panel portion and the outer panel portion.

In another alternative embodiment, there is provided a riding assistance device for use with a horseback riding saddle of the type including a body arranged about a central axis, the body having a proximal region to be adjacent a neck region of a horse, the body including a pair of lateral portions extending outwardly from the central axis, each of the lateral portions having an inner panel portion providing an inner surface region for engaging a corresponding back region of the horse and an outer panel portion providing an outer surface for receiving a corresponding thigh region of a horseback rider. The safety device comprises a gripping bar portion arranged to be oriented transverse to the central axis and adjacent the proximal region. The gripping bar portion has a pair of opposed end regions and a pair of support portions, each extending from a corresponding end region. The support portions are arranged to be located on opposite sides of the central axis and being formed to be removably inserted to the saddle adjacent one or more of the on each side of the central axis.

### BRIEF DESCRIPTION OF THE DRAWINGS

Several preferred embodiments of the present invention will be provided, by way of examples only, with reference to the appended drawings, wherein:

FIG. 1 is a side view of a saddle assembly on a horse;

FIG. 2 is a plan view of the assembly of FIG. 1;

FIG. 3 is perspective view of the assembly of FIG. 1 in another orientation;

FIG. 4 is a sectional view taken on line 4-4 of FIG. 2;

FIG. 5 is a perspective view of an assistance unit used in the assembly of FIG. 1; and

FIGS. 6a, 6b and 6c are side, plan and end views, respectively, of the assistance unit of FIG. 5.

### DESCRIPTION OF THE PREFERRED EMBODIMENTS

It should be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Furthermore, and as described in subsequent paragraphs, the specific mechanical configurations illustrated in the drawings are intended to exemplify embodiments of the invention. However, other alternative mechanical configurations are possible which are considered to be within the teachings of the instant disclosure. Furthermore, unless otherwise indicated, the term “or” is to be considered inclusive.

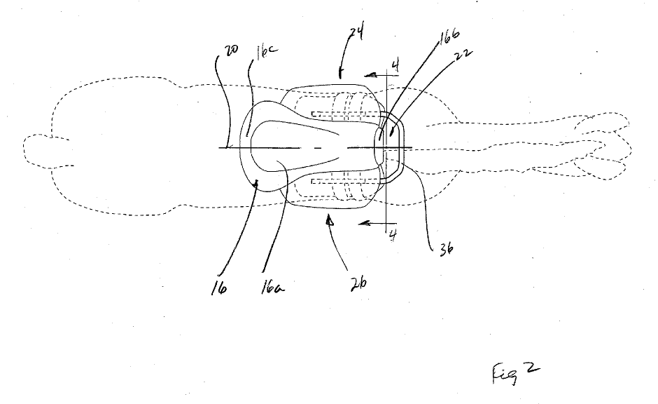

Referring to the figures, there is provided a horseback riding assembly 10 including a saddle 12 for mounting on a horse 14. The saddle 12 has a body 16 with an outer surface 16a arranged about a central axis 20 (FIG. 2) with a front end or proximal region 22 provided by a pommel 16b to be adjacent a neck region of the horse 14 and a rear end provided by a cantle 16c.

Extending outwardly from the body 16 is a pair of lateral portions 24, 26. Each has an inner panel portion 28 providing an inner surface region for engaging a corresponding back region of the horse 14 and an outer panel portion 30 providing an outer surface for receiving a corresponding thigh region of a horseback rider. The saddle includes one or more girth straps shown in an operative position at 32.

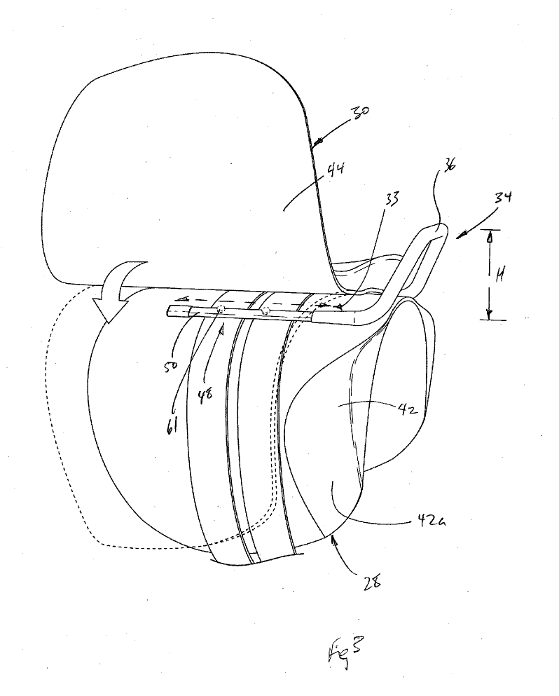

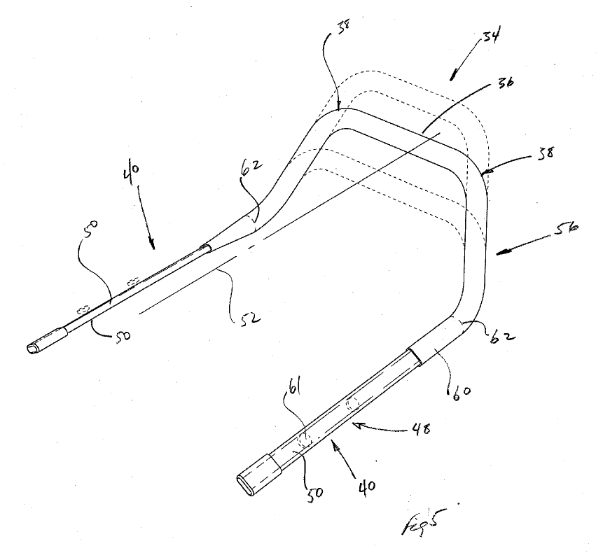

Referring to FIG. 3, an assistance bar unit 34 is removably inserted along an access path 33 between the inner panel portion 28 and the outer panel portion 30. The assistance bar unit 34 includes a gripping bar portion 36 with a pair of opposed end regions 38 (FIG. 5) which are joined to a support portion 40. The gripping bar portion 36 is arranged to be oriented transverse to the central axis 20 and adjacent the proximal region 22, or the front end of the saddle, thus within easy reach of a horse back rider.

The support portions 40 are arranged to be located on opposite sides of the central axis 20 and are formed to be insertable along the access path 33 (FIG. 3) and thus between the inner panel portion 28 and the outer panel portion 30 and to be complementary therewith.

In this example, the inner panel portion 28 includes a saddle pad member 42 with a knee roll 42a and the outer panel portion 30 includes an outer saddle flap 44.

Each support portion 40 includes a longitudinal brace portion 48 (FIG. 5) with a generally symmetrical and flattened profile. Each longitudinal brace portion 48 has a pair of opposed surfaces 50 which are generally symmetrically aligned with a longitudinal brace axis 52. In this case, the opposed surfaces 50 are arranged to be inclined toward the longitudinal brace axis 52.

The assistance bar unit 34 also includes a pair of strut portions 56, each of which is inclined between and joining the gripping bar portion 36 with the corresponding longitudinal brace portion 48. The gripping bar portion 36, the longitudinal brace portions 48 and the strut portions 56 are, in this case, integrally formed of a single tubular blank

A cover layer 60 extends along the gripping bar portion 36 and at least part of each strut portion 56 and/or the longitudinal brace portion 48. In this case, the cover layer 60 is a resilient material which may include a polymer and/or rubber material.

Referring to FIG. 3, the assistance bar unit 34 is held in place, simply by the snug fit between the longitudinal brace portions 48 and the inner and outer panel portions 28, 30. However, at least one fastener as shown in dashed lines at 61 may be provided, if desired, on each longitudinal brace portion 48 for removably securing the longitudinal brace portion 48 with the inner panel 28 portion and/or the outer panel portion 30, as desired. Other removable fasteners may be utilized such as, for instance, hook and loop fasteners such as those available under the trademark VELCRO.

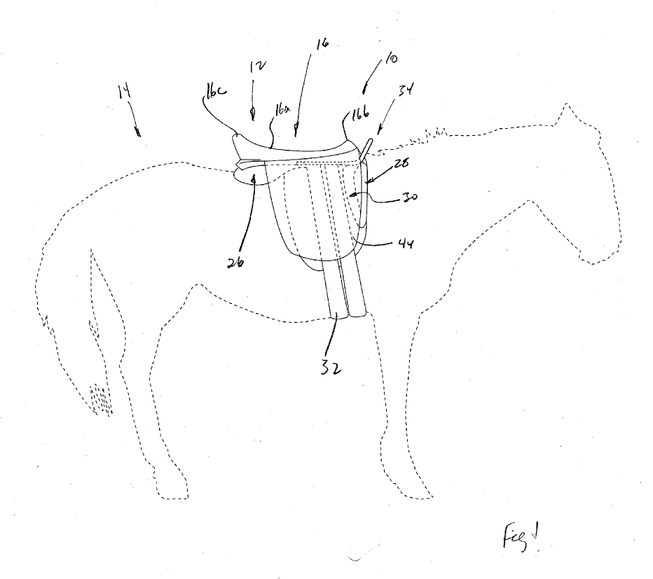

Thus, the riding assembly 10 may be used as follows. With an able bodied horse at hand, the saddle 12 is first placed on the horse's back and oriented as shown in FIG. 1. The assistance bar unit 34 is then installed along the access path 33 between the saddle pad 42 and the outer saddle flap 44 until it is fully in place to provide the gripping bar sufficient support. This support becomes operable when the rider climbs into the saddle since the rider's weight is thus brought to bear against the outer saddle flap and thus pressing the latter against the longitudinal brace portions 48. Thus, in this example, the assistance bar unit may simply be kept in place by its insertion under the saddle flap and the weight of the rider keeping it secure.

It is, of course, desirable that the longitudinal brace portions be positioned relative to the body 16 and the corresponding outer saddle flap 44 and the saddle pad 42 to minimize discomfort to the rider. This should be further minimized by the relative thickness of the outer saddle flap 44 that will tend to follow a more gradual contour over the profile of the longitudinal brace portion 48. In addition, the saddle pad 42 may also relatively thick to enable it to allow the corresponding longitudinal brace portion to “seat” therein, to reduce the effect to it projects upwardly beyond the contour of the outer surface 16a of the body 16. In this position, the gripping bar portion extends well above the outer surfaced 16a, thus providing a reasonably stable handle should the rider need additional support therefrom.

The assistance bar unit 34 may be provided with different operative heights “H” as shown in FIG. 5 to provide a range of assistance bar units 34 to accommodate the needs of different riders. If desired, the strut portions 56 may be made adjustable to provide different heights “H” in a single assistance bar unit, for example by way of telescoping portions provided in each strut portion 56, as represented schematically by the dashed separation lines 62.

While the assistance bar unit 34 is engagable with and between the inner and outer panel portions, the assistance bar unit may also be provided as a riding assistance device which is attachable or adjacent to other locations on the saddle to provide the gripping bar portion in a similar location. In addition, the gripping bar portion may also be arranged to be provided across the rear end of the saddle, should that be useful in some instances, or for that matter in tandem at both the front and rear regions of the saddle. Still further, the assistance bar unit may be integrally formed with a saddle during its manufacture.

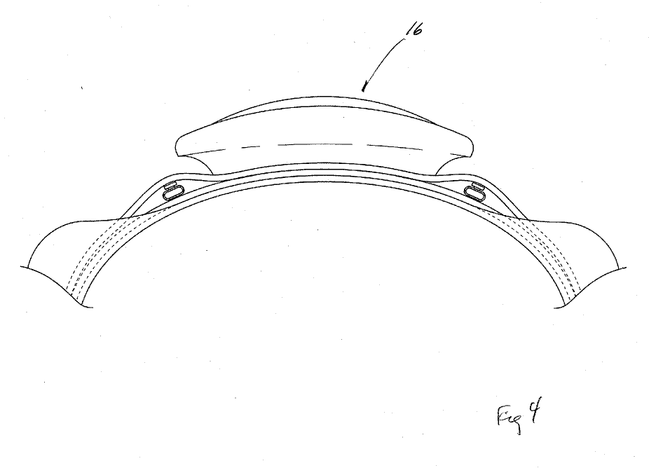

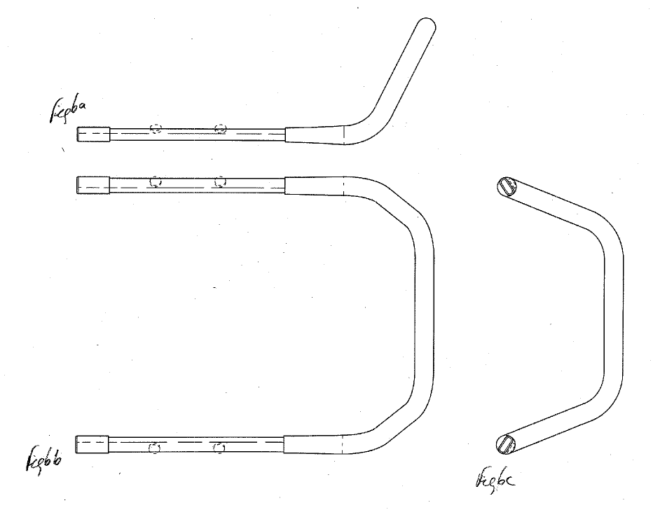

Thus, in one example, the horseback riding assembly provides an alternative to the imbalanced or insecure rider by allowing the rider to insert a handle bar like device when saddling up under the saddle flaps, for example as illustrated in FIGS. 1 to 6c. Thus, in one example, a handle bar like device may be kept in place by inserting each of a pair of flat end portions under a corresponding saddle flap enabling the weight of the rider to keep the device firmly in place during the ride. The device has a central portion which is curved outwards and over the front of the saddle providing a raised handle bar which is secure and does not interfere with the horse's actions, while providing the rider with greater stability.

While the present invention has been described for what are presently considered the preferred embodiments, the invention is not so limited. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A horseback riding assembly comprising a saddle, the saddle including a body arranged about a central axis, the body having a proximal region to be adjacent a neck region of a horse, the body including a pair of lateral portions extending outwardly from the central axis, each of the lateral portions having an inner panel portion providing an inner surface region for engaging a corresponding back region of the horse and an outer panel portion providing an outer surface for receiving a corresponding thigh region of a horseback rider, the body including an access path between the inner panel portion and the outer panel portion, an assistance bar unit including a gripping bar portion arranged to be oriented transverse to the central axis and adjacent the proximal region, the gripping bar portion having a pair of opposed end regions, a pair of support portions, each extending from a corresponding end region, the support portions being arranged to be located on opposite sides of the central axis and being formed to be insertable along the access path and between the inner panel portion and the outer panel portion and to complementary therewith.

2. An assembly as designed in claim 1, the inner panel portion including a saddle pad member and the outer panel portion including an outer saddle flap.

3. An assembly as defined in claim 2, each support portion including a longitudinal brace portion, each longitudinal brace portion having a flattened profile with a pair of opposed surfaces which are generally symmetrically aligned with a longitudinal brace axis.

4. An assembly as defined in claim 2, each support portion including a longitudinal brace portion, each longitudinal brace having a flattened profile with a pair of substantially planar opposed surfaces which are generally symmetrically aligned with a longitudinal brace axis.

5. An assembly as defined in claim 2, each support portion including a longitudinal brace portion, each longitudinal brace portion having a flattened profile with a pair of substantially planar opposed surfaces.

6. An assembly as defined in claim 5, the opposed surfaces being arranged to be inclined toward the central axis.

7. An assembly as defined in claim 6, further comprising a pair of strut portions, each strut portion being inclined between and joining the gripping bar portion with the corresponding support portion.

8. An assembly as defined in claim 7, the gripping bar portion, the support portion and the strut portions being integrally formed of a single tubular blank.

9. An assembly as defined in claim 8, further comprising a cover layer extending along the gripping bar portion and at least part of each strut portion and/or the support portion.

10. An assembly as defined in claim 9, the cover layer being a resilient material.

11. An assembly as defined in claim 10, the resilient layer including a polymer and/or rubber material.

12. An assembly as defined in claim 1, further comprising at least one fastener for removably securing each support portion with the inner panel portion and/or the outer panel portion.

13. A horseback riding assembly comprising a horse having a neck region and a back region having a left hand side and a right hand side, a saddle positioned on the horse, the saddle including a body symmetrically arranged about a central axis, the body having a proximal region to be adjacent the neck region, the body including a left hand lateral portion and a right hand lateral portion extending outwardly from the central axis, each of the lateral portions having an inner panel portion providing an inner surface region engaging the corresponding back region, and an outer panel portion providing an outer surface for receiving a corresponding thigh region of a horseback rider, the body including an access path between the inner panel portion and the outer panel portion, an assistance unit including a gripping bar portion oriented transverse to the central axis and adjacent the proximal region, the gripping portion having a pair of opposed end regions, the assistance bar unit further including a pair of support portions, each extending from a corresponding end region, the support portions located on opposite sides of the central axis and located within the access path in an operative orientation complementary with the inner panel portion and the outer panel portion.

14. A method of horseback riding, comprising:
providing a horse with a neck region and a back region having a left hand side and a right hand side,
providing a saddle with a body arranged about a central axis, a proximal region to be adjacent the neck region, the body including a left hand lateral portion and a right hand lateral portion extending outwardly from the central axis, each of the lateral portions having an inner panel portion providing an inner surface region engaging the corresponding back region, and an outer panel portion providing an outer surface for receiving a corresponding thigh region of a horseback rider, the body including an access path between the inner panel portion and the outer panel portion,
providing an assistance bar unit with a gripping bar portion having a pair of opposed end regions and a pair of anchor portions, each extending from a corresponding end region,
installing the saddle on the horse;
locating the support portions on opposite sides of the central axis and within the access path in an operative orientation complementary with the inner panel portion and the outer panel portion.

15. A riding assistance device for use with a horseback riding saddle of the type including a body arranged about a central axis, the body having a proximal region to be adjacent a neck region of a horse, the body including a pair of lateral portions extending outwardly from the central axis, each of the lateral portions having an inner panel portion providing an inner surface region for engaging a corresponding back region of the horse and an outer panel portion providing an outer surface for receiving a corresponding thigh region of a horseback rider, the safety device comprising a gripping bar portion arranged to be oriented transverse to the central axis and adjacent the proximal region, the gripping bar portion having a pair of opposed end regions, a pair of support portions, each extending from a corresponding end region, the support portions being arranged to be located on opposite sides of the central axis and being formed to be removably inserted to the saddle adjacent one or more of the on each side of the central axis.
